(19) United States
(12) Patent Application Publication
(10) Pub. No.: US 2007/0265894 A1
(43) Pub. Date: Nov. 15, 2007

(54) System, method, and computer program product for enterprise operations management

(75) Inventors: Douwe Van de Voort, Nieuwegein City (NL); Dennis Rietvink, Oostherhout (NL)

Correspondence Address: DOCKET CLERK, DM/EDS, P.O. DRAWER 800889, DALLAS, TX, 75380, US

(73) Assignee: Electronic Data Systems Corporation, Plano, TX (US)

(21) Appl. No.: 11/431,201

(22) Filed: May 9, 2006

(51) Int. Cl. G06F 17/50

(52) U.S. Cl. 705/7

(57) ABSTRACT

A method and computer program product for operations management, including receiving an alert in an enterprise operations management system from an operations management data processing system and receiving a resolution to the alert. The method and computer program product also includes launching a task in the enterprise operations management system corresponding to the alert resolution and forwarding the task from the enterprise operations management system for execution on the operations management data processing system. A system in which the method can be implemented is also discussed.

### TECHNICAL FIELD OF THE INVENTION

The present invention is directed, in general, to enterprise operations management systems.

### BACKGROUND OF THE INVENTION

Conventional operations management (OM) systems are well known in the art. One well-known example is MICROSOFT OPERATIONS MANAGER 2005. Known OM system are essentially a single-enterprise solution, in that it is not possible to build a hierarchy of OM groups that span multiple security contexts. As each individual customer will have a separate security context, conventional OM systems generally cannot manage multiple customers from a single leveraged location.

OM systems are particularly useful in information technology infrastructures, for managing systems status and problems. An OM system can typically monitor one or more systems, alert to problems, and receive resolutions to problems from a technical support person. Unfortunately, current OM systems generally require that all monitoring, alerting, and problem resolution be performed on a single-enterprise basis.

There is, therefore, a need in the art for a system, process and computer program product for unified management of multiple OM groups.

### SUMMARY OF THE INVENTION

Various embodiments include a method and computer program product for operations management, including receiving an alert in an enterprise operations management system from an operations management data processing system and receiving a resolution to the alert. The method and computer program product also includes launching a task in the enterprise operations management system corresponding to the alert resolution and forwarding the task from the enterprise operations management system for execution on the operations management data processing system.

Other embodiments include an operations management system, comprising an enterprise data processing system implementing a enterprise operations management system capable of managing at least two operations management groups and a connector framework connected to communicate between the enterprise data processing system and an operations management data processing system in a first one of the at least two operations management groups, the operations management data processing system managing the operations of the first one of the at least two operations management groups. The system also includes a console framework connected to communicate between the enterprise tat processing system and at least one operator console.

The foregoing has outlined rather broadly the features and technical advantages of the present invention so that those skilled in the art may better understand the detailed description of the invention that follows. Additional features and advantages of the invention will be described hereinafter that form the subject of the claims of the invention. Those skilled in the art will appreciate that they may readily use the conception and the specific embodiment disclosed as a basis for modifying or designing other structures for carrying out the same purposes of the present invention. Those skilled in the art will also realize that such equivalent constructions do not depart from the spirit and scope of the invention in its broadest form.

Before undertaking the DETAILED DESCRIPTION OF THE INVENTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the terms “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIG. 1 depicts a block diagram of a data processing system in which a preferred embodiment can be implemented;

FIG. 2 depicts a block diagram of a data processing system network in which a disclosed embodiment of the present invention can be implemented; and

FIG. 3 depicts a flowchart of an exemplary process in accordance with a disclosed embodiment.

### DETAILED DESCRIPTION OF THE INVENTION

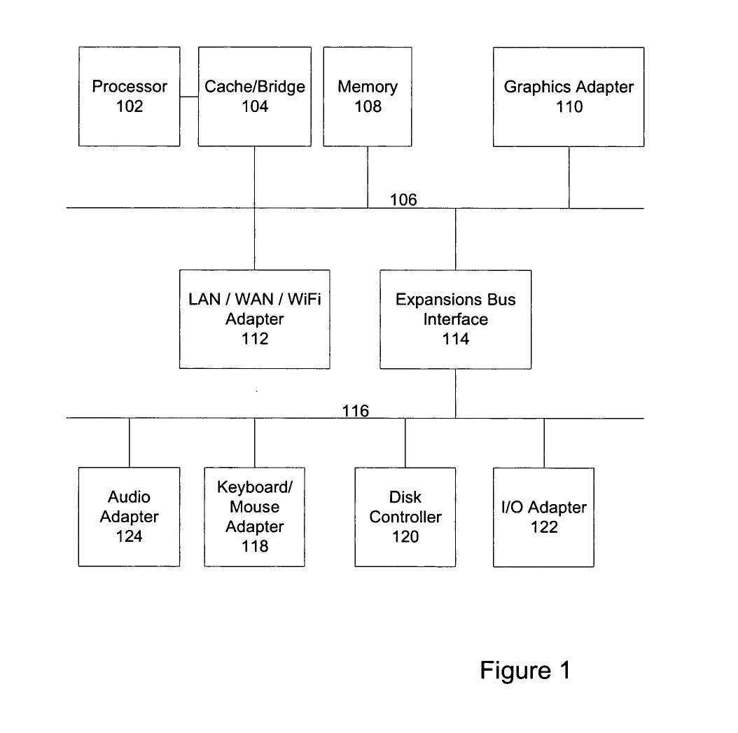

FIGS. 1 through 3, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged device. The numerous innovative teachings of the present application will be described with particular reference to the presently preferred embodiment.

FIG. 1 depicts a block diagram of a data processing system in which a preferred embodiment can be implemented. The data processing system depicted includes a processor 102 connected to a level two cache/bridge 104, which is connected in turn to a local system bus 106. Local system bus 106 may be, for example, a peripheral component interconnect (PCI) architecture bus. Also connected to local system bus in the depicted example are a main memory 108 and a graphics adapter 110.

Other peripherals, such as local area network (LAN)/Wide Area Network/Wireless (e.g. WiFi) adapter 112, may also be connected to local system bus 106. Expansion bus interface 114 connects local system bus 106 to input/output (I/O) bus 116. I/O bus 116 is connected to keyboard/mouse adapter 118, disk controller 120, and I/O adapter 122.

Also connected to I/O bus 116 in the example shown is audio adapter 124, to which speakers (not shown) may be connected for playing sounds. Keyboard/mouse adapter 118 provides a connection for a pointing device (not shown), such as a mouse, trackball, trackpointer, etc.

Those of ordinary skill in the art will appreciate that the hardware depicted in FIG. 1 may vary for particular. For example, other peripheral devices, such as an optical disk drive and the like, also may be used in addition or in place of the hardware depicted. The depicted example is provided for the purpose of explanation only and is not meant to imply architectural limitations with respect to the present invention.

A data processing system in accordance with a preferred embodiment of the present invention includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present invention as described.

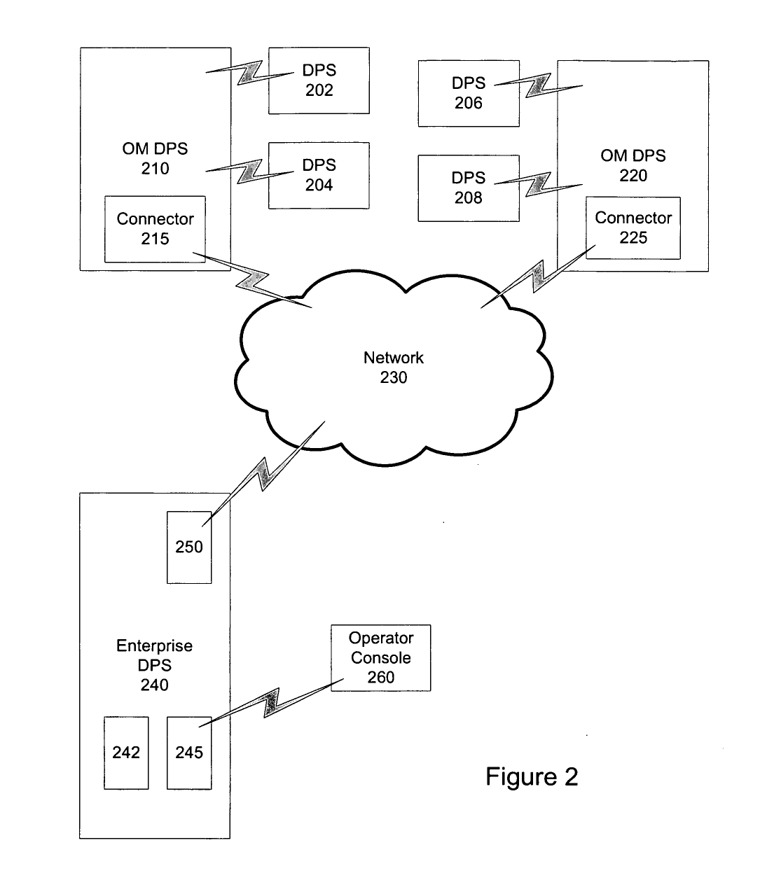

FIG. 2 depicts a block diagram of a data processing system network in which a disclosed embodiment of the present invention can be implemented.

FIG. 2 depicts a block diagram of a data processing system network in which an embodiment of the present invention can be implemented. Shown here are OM data processing system 210 including an associated enterprise operations manager (EOM) connector 215; OM data processing system 220 including an associated enterprise operations manager (EOM) connector 225; and enterprise data processing system 240.

OM data processing system 210 and OM data processing system 220 are each connected to manage multiple other data processing systems. In this figure, OM data processing system 210 is connected to manage data processing systems 202 and 204, and OM data processing system 220 is connected to manage data processing systems 206 and 208. While each OM data processing system is only shown managing two data processing systems in this example, those of skill in the art will recognize that each OM data processing system can manage any number of other data processing systems.

OM data processing systems 210 and 220, and enterprise data processing system 240, are all connected to communicate via network 230, using known network communication techniques. Data processing systems 210, 220, and 240 can each be implemented as data processing system 100 shown in FIG. 1, or can be modified, as known to those of skill in the art, as necessary for a particular implementation. In particular, each of data processing systems 210, 220, and 240 can be implemented as a single data processing system, or can represent multiple data processing systems. Network 230 can be a public or private network, or combination of these, including the Internet, so long as it can provide communications between the data processing systems shown, as will be described below.

In some embodiments, OM data processing system 210 and associated EOM connector 215 and data processing systems 202 and 204 are part of a first OM group, and OM data processing system 220 and associated EOM connector 225 and data processing systems 206 and 208 are part of a second OM group. In some embodiments, each of these OM groups is a management group using MICROSOFT Operations Manager 2005 or a similar OM software product, including an OM software product executing on at least OM data processing system 210/220. In various implementations, the first and second OM groups are part of different customer enterprises, and span different security contexts, and are otherwise unrelated to each other. In other implementations, any number of OM groups can be used, some of which may be able to communicate between each other, while others are maintained as strictly isolated from each other for security purposes.

In some embodiments, OM data processing system 210 and EOM connector 215 are implemented as a single data processing system, where EOM connector 215 is a connector service physically implemented in OM data processing system 210. Similarly, in some embodiments, OM data processing system 220 and EOM connector 225 are implemented as a single data processing system, where EOM connector 225 is a connector service physically implemented in OM data processing system 220.

Enterprise data processing system 240 hosts an enterprise operations management (EOM) system, as described herein. In some embodiments, the EOM system includes an EOM Console Framework 245 and an EOM Connector Framework 250. Both layers are present in the central EOM infrastructure. This central EOM infrastructure consists of one OM management group and a OM reporting server.

The EOM Console Framework 245 is used to connect end-users to EOM. The EOM Connector Framework 245 is used to communicate between the EOM system and the first and second OM groups, preferably by way of connector data processing systems 215 and 225.

Preferably, the EOM system is presented to the end-user with two consoles, the EOM Administrator console and the EOM Operator console. The EOM Administrator console can be used to configure EOM specific functionality, like the administration of customers, team based security and task enrichment. A typical user of the EOM administrator console can be a member of the team that is responsible for maintaining the EOM environment itself.

The EOM Operator console is preferably optimized for incident resolution and task automation. The EOM operator console can be used to manage more then one customer, can be aware of the team based security layer and can offer the enhanced task automation function.

A typical user of the EOM operator console can be a member of any support team managing a server or applications or helpdesk staff performing management tasks such as installs, moves, adds, and changes (IMAC) requests on server-based environments. These requests are launched as tasks on the EOM system to be forwarded to the individual OM groups and systems as described herein.

In some embodiments, the EOM Consoles are MICROSOFT WINDOWS applications and connect to the EOM Console Framework.

The EOM Console Framework 245 preferably handles all interaction between an end user, such as helpdesk or support personnel or others, on an operator console and the central EOM infrastructure. It enables all functionality that is represented in the EOM administrator and operator console. The EOM Console Framework is also responsible for enforcing the team based security model. Preferably, the EOM Console Framework is implemented as a web service. A generic operator console 260 is shown, capable of communicating with EOM Console Framework 245 for any of the management and operation tasks described herein.

The EOM Connector Framework 250 is the layer between the first and second OM management groups and the central EOM infrastructure. It ensures that all functionality offered by the EOM Console Framework is not only available on one OM management group but on all OM management groups connected by the EOM Connector Framework.

Preferably, the EOM system includes a central OM management group that can hold all synchronized operational data of all first and second OM groups (and any others) that have been connected with the EOM Connector Framework 250. Data types that can be synchronized include Computer and Computer Attributes, States, Alerts, Discovery Data, and Task Results.

Besides the synchronization of operational data used by the EOM Console Framework 245, the EOM Connector Framework 250 can include an optional functionality to collect filtered reporting data (performance counters and operating system events, for example) from all connected OM groups to the central OM management group reporting database. These filters are defined on a customer basis using an EOM administrator console, connected as described below. EOM is designed to only transfer a limited set of data used for reporting purposes.

In some embodiments, the EOM Connector Framework 250 is implemented as web service or a a set of web services in the enterprise data processing system 240.

EOM Connectors 215/225 are the active components of OM data processing systems 210/220 of the OM management groups responsible for data synchronization. Each EOM connector 215/225 connects to the EOM Connector Framework 250 in the central OM infrastructure via network 230. In some embodiments, EOM Connectors 214/225 are implemented as Windows services.

In various embodiments, an EOM Alert Manager 242 is responsible for managing alerts from the central OM management group on enterprise DPS 240 and for keeping alert states synchronized throughout the OM hierarchy.

The EOM Connector Framework 250 communicates with the EOM Connectors 215/225 to allow the EOM system on enterprise data processing system 240 to launch tasks on OM data processing systems 210/220 individually or as a group, regardless of whether OM data processing systems 210/220 are co-located, located and operated by different customers or enterprises, or otherwise. Preferably, a complete task history is kept in a database of the EOM system and can be viewed at any time using the EOM Console Framework 245.

Various embodiments allow task automating and centralization of extended operational data across multiple OM groups, which can be separate enterprises. Similarly, in some environments, the reporting data such as performance counters and events are centralized across multiple OM groups.

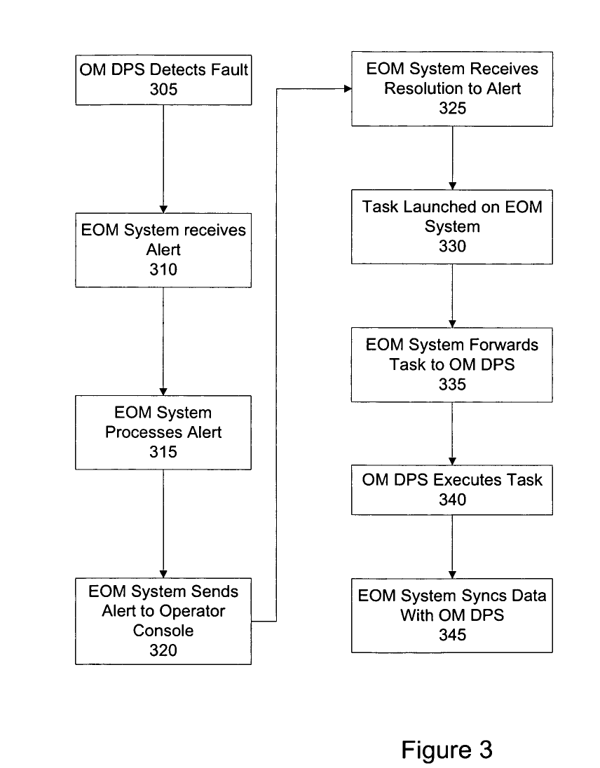

FIG. 3 depicts a flowchart of a process in accordance with a disclosed embodiment. For ease of description, this exemplary process will be described in terms of the systems depicted in FIG. 2. Of course, such processes and techniques can be applied to other and differently-configured data processing systems and networks.

In this example, OM data processing system 210 detects a fault on managed data processing system 202 (step 305).

OM data processing system 210 uses connector 215 to sent the fault, via network 230, to be received by the EOM system via the EOM Connector Framework 250 on enterprise data processing system 240 (step 310).

The EOM system on enterprise data processing system 240 processes the alert (step 315), preferably using the EOM Alert Manager and in some cases can automatically determine a resolution to the alert.

When necessary, an alert notification corresponding to the alert is sent by the EOM system, using EOM Console Framework 245, to one or more operator consoles 260 (step 320).

If the alert is resolved by an operator, the EOM system receives a resolution to the incident from an operator console 260 via EOM Console Framework 245 (step 325).

The resolution to the alert can include one or more tasks to be executed. A task corresponding to the alert is launched on the EOM system on the enterprise data processing system 240 (step 330). This task can be launched, for example, in response to an automatic resolution as in step 320, or preferably by an operator via the operator console 260.

The EOM system forwards the task from enterprise data processing system 240 to OM data processing system 210, via EOM Connector Framework 250, network 230, and connector 215 (step 335).

OM data processing system 210 will then execute the task to resolve the alert (step 340).

In some cases, the EOM system on enterprise data processing system will synchronize operational data with OM data processing system 210 via EOM Connector Framework 250, network 230, and connector 210 (step 345). Data types that can be synchronized include Computer and Computer Attributes, States, Alerts, Discovery Data, and Task Results.

Of course, in implementation, there may be multiple different or like alerts, and the resolution may include multiple tasks to be executed.

Also, in implementation, the EOM system will manage alerts from multiple OM data processing systems and groups. Similarly, during synchronization the EOM system can synchronize with multiple OM data processing systems and groups.

Various embodiment also allow for task automation of IMACs, wherein management tasks including IMAC requests can be launched on the EOM system, as in step 330, and forwarded to the OM data processing system for execution as in steps 335 and 340. The management task can include one of an install request, move request, add request, or change request directed to a system managed by the operations data processing system.

Although FIG. 3 illustrates one example of a method 300 for using wireless communications for process elements, various changes may be made to FIG. 3. For example, one, some, or all of the steps may occur as many times as needed. Also, while shown as a sequence of steps, various steps in FIG. 3 could occur in parallel or in a different order.

Those skilled in the art will recognize that, for simplicity and clarity, the full structure and operation of all data processing systems suitable for use with the present invention is not being depicted or described herein. Instead, only so much of a data processing system as is unique to the present invention or necessary for an understanding of the present invention is depicted and described. The remainder of the construction and operation of data processing system 100 may conform to any of the various current implementations and practices known in the art.

It is important to note that while the present invention has been described in the context of a fully functional system, those skilled in the art will appreciate that at least portions of the mechanism of the present invention are capable of being distributed in the form of a instructions contained within a machine usable medium in any of a variety of forms, and that the present invention applies equally regardless of the particular type of instruction or signal bearing medium utilized to actually carry out the distribution. Examples of machine usable mediums include: nonvolatile, hard-coded type mediums such as read only memories (ROMs) or erasable, electrically programmable read only memories (EEPROMs), user-recordable type mediums such as floppy disks, hard disk drives and compact disk read only memories (CD-ROMs) or digital versatile disks (DVDs), and transmission type mediums such as digital and analog communication links.

Although an exemplary embodiment of the present invention has been described in detail, those skilled in the art will understand that various changes, substitutions, variations, and improvements of the invention disclosed herein may be made without departing from the spirit and scope of the invention in its broadest form.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC §112 unless the exact words “means for” are followed by a participle.

What is claimed is:

1. A method for operations management, comprising:
receiving an alert in an enterprise operations management system from an operations management data processing system;
receiving a resolution to the alert;
launching a task in the enterprise operations management system corresponding to the alert resolution; and
forwarding the task from the enterprise operations management system for execution on the operations management data processing system.

2. The method of claim 1, wherein the alert is received via an enterprise operations management connector framework.

3. The method of claim 1, wherein the alert is received from a connector associated with the operations management data processing system.

4. The method of claim 1, wherein the alert is received from a connector web service implemented in the operations management data processing system.

5. The method of claim 1, wherein the resolution is received from an operator console.

6. The method of claim 1, wherein the task is launched from an operator console.

7. The method of claim 1, further comprising synchronizing operational data between the enterprise operations management system and operations management data processing system.

8. The method of claim 7, wherein the operational data includes multiple data types including Computer and Computer Attributes, States, Alerts, Discovery Data, and Task Results.

9. The method of claim 1, further comprising receiving an alert in the enterprise operations management system from a second operations management data processing system, wherein the operations management data processing system and the second operations management data processing system are not part of the same business enterprise.

10. A method for operations management, comprising:
launching a management task in an enterprise operations management system connected to communicate with at least one operations management data processing system; and
forwarding the task from the enterprise operations management system for execution on the operations management data processing system.

11. The method of claim 10, wherein the management task includes one of an install request, move request, add request, or change request directed to a system managed by the operations data processing system.

12. The method of claim 10, wherein the management task is received from an operator console connected to communicate with the enterprise operations management system.

13. The method of claim 10, further comprising collecting reporting data including performance counters and events from multiple operations management data processing systems.

14. The method of claim 10, further comprising collecting extended operational data from multiple operations management data processing systems.

15. A computer program product tangibly embodied in a machine-usable medium, comprising:
instructions for receiving an alert in an enterprise operations management system from an operations management data processing system;
instructions for receiving a resolution to the alert;
instructions for launching a task in the enterprise operations management system corresponding to the alert resolution; and
instructions for forwarding the task from the enterprise operations management system for execution on the operations management data processing system.

16. The computer program product of claim 15, wherein the alert is received via an enterprise operations management connector framework.

17. The computer program product of claim 15, wherein the alert is received from a connector associated with the operations management data processing system.

18. The computer program product of claim 15, wherein the alert is received from a connector web service implemented in the operations management data processing system.

19. The computer program product of claim 15, wherein the resolution is received from an operator console.

20. The computer program product of claim 15, wherein the task is launched from an operator console.

21. The computer program product of claim 15, further comprising instructions for synchronizing operational data between the enterprise operations management system and operations management data processing system.

22. The computer program product of claim 21, wherein the operational data includes multiple data types including Computer and Computer Attributes, States, Alerts, Discovery Data, and Task Results.

23. An operations management system, comprising:
an enterprise data processing system implementing a enterprise operations management system capable of managing at least two operations management groups;
a connector framework connected to communicate between the enterprise data processing system and an operations management data processing system in a first one of the at least two operations management groups, the operations management data processing system managing the operations of the first one of the at least two operations management groups; and
a console framework connected to communicate between the enterprise tat processing system and at least one operator console.

24. The operations management system of claim 23, wherein the connector framework communicates with a connector service on the operations management data processing system.

25. The operations management system of claim 23, wherein the enterprise operations management system is capable of launching tasks to be executed by the operations management data processing system.

26. The operations management system of claim 23, wherein the enterprise operations management system is capable of synchronizing operational data with the operations management data processing system.

27. The operations management system of claim 26, wherein the operational data includes multiple data types including Computer and Computer Attributes, States, Alerts, Discovery Data, and Task Results.
